(19) United States
(12) Patent Application Publication
(10) Pub. No.: US 2014/0230577 A1
(43) Pub. Date: Aug. 21, 2014

(54) REAL-TIME MEASUREMENT SYSTEM FOR MONITORING AND/OR CONTROLLING PROPERTIES OF A COMPOSITION TRANSITIONING FROM LIQUID STATE TO SOLID STATE

(71) Applicants: Mukerrem Cakmak, Munroe Falls, OH (US); Emre Unsal, Painesville, OH (US); Baris Yalcin, Woodbury, MN (US); Jason E. Drum, Avon Lake, OH (US); Orcun Yucel, Akron, OH (US); Isik Isil Nugay, Santa Clara, CA (US)

(72) Inventors: Mukerrem Cakmak, Munroe Falls, OH (US); Emre Unsal, Painesville, OH (US); Baris Yalcin, Woodbury, MN (US); Jason E. Drum, Avon Lake, OH (US); Orcun Yucel, Akron, OH (US); Isik Isil Nugay, Santa Clara, CA (US)

(73) Assignee: THE UNIVERSITY OF AKRON, Akron, OH (US)

(21) Appl. No.: 14/186,377

(22) Filed: Feb. 21, 2014

Related U.S. Application Data
(60) Provisional application No. 61/767,428, filed on Feb. 21, 2013.

(51) Int. Cl. G01N 25/04; G01B 11/06; G01N 21/41; G01N 1/44

(52) U.S. Cl. CPC G01N 25/04; G01N 1/44; G01B 11/0616; G01N 21/41
USPC 73/863.11; 356/36; 250/493.1; 374/142; 177/1; 177/50

(57) ABSTRACT

A method of monitoring a composition in transition from liquid to solid state includes the steps of providing an apparatus having a temperature pyrometer, a drying element, a laser displacement sensor, and an electronic balance; providing a composition in a liquid state; converting the composition to a solid state; and measuring the a process condition during said step of converting. The apparatus can include a drying element, a temperature pyrometer, a laser displacement sensor, a platform for holding a composition, an electronic balance, and a spectral birefringence measurement system.

### CROSS-REFERENCE TO RELATED APPLICATIONS

This application claims priority from U.S. Provisional Application No. 61/767,428 filed on Feb. 21, 2013, the contents of which are incorporated herein by reference.

### FIELD OF THE INVENTION

The present invention relates to an apparatus for tracking real-time conditions. The present invention further relates to an automated apparatus for monitoring and/or controlling real-time conditions of a composition transitioning from a liquid state to a solid state. The present invention further relates to a method of monitoring and/or controlling real-time conditions of a drying process.

### BACKGROUND OF THE INVENTION

Drying is a common method that is used by various manufacturing disciplines to produce large quantities of products. The common goal of the drying process in all different processing industries is to produce a good quality product in an optimized medium by precisely controlling the drying conditions. For instance, in food processing, the aim is to produce products with highest level of nutrient and flavors, while in polymer processing one of the aims is to produce films with uniform thickness distribution, high optical clarities, and desired optical anisotropies such as in the cast of optical retarders used in construction of LCD displays.

Typically polymer solutions are deposited on substrates using electro-spraying, ultrasonic coating, doctor blade casting or slot die coating to manufacture products including protective coatings, films for membranes, and optical and electrical applications. The solution is then dried via application of conductive heat sources through the substrates and/or convective air flow across the free surface of the cast films.

During the drying phase, the solution undergoes a series of stages as the solvent molecules diffuse to the free surface and then evaporate. The details of this drying, which are controlled by process and material parameters, dramatically affect the final structure and properties of coatings and films. The organization and assembly of macromolecules that are deposited on inorganic substrates has been studied. It was found that substrate properties, solution organization, and interfacial characteristics of macromolecules are the important elements controlling the process.

As the evaporation of the solvent from the medium continues, the loss of solvent causes shrinkage that is accompanied by ensuing solidification of the material. This shrinkage mainly occurs in the thickness direction since the solution is typically constrained in the film plane on the substrate to which it generally adheres. This is manifested in significant reduction of the thickness of the coating or film during drying.

Traditionally, the final properties of solution cast and dried are evaluated through a series of offline characterization methods. These offline studies have helped to understand the final properties but have not revealed the temporal development of mechanistic changes that occur during the course of drying. The treatment of these complex physical processes as a “black box” makes it difficult to develop models to quantify the dynamics of the physical and chemical processes that take place during the course of drying.

Other efforts have been made to predict the drying characteristics of a solution. The validation of these modeling studies, however, has been hampered by lack of high quality real-time data.

Thus, it is desired to provide an apparatus for tracking real-time conditions. It is further desired to provide an automated apparatus for monitoring and controlling real-time conditions of a composition transitioning from a liquid state to a solid state. The apparatus offers one or more of the following improvements: ability to track the weight, ability to track the temperature, ability to track the thickness, ability to track the concentration of a solute, providing both in plane birefringence and out of plane birefringence, and subjection to convective heating.

### SUMMARY OF THE INVENTION

In a first embodiment, the present invention provides a method of monitoring a composition in transition from liquid to solid state, comprising the steps of (a) providing an apparatus comprising a temperature pyrometer, a drying element, a laser displacement sensor, and an electronic balance; (b) providing a composition in a liquid state; (c) converting the composition to a solid state; and (d) measuring a process condition selected from the group consisting of temperature, thickness, and weight of the composition, during said step of converting.

In a second embodiment, the present invention provides a method as in the first embodiment, wherein step (d) includes measuring two or more of the process conditions selected from the group consisting of temperature, thickness, and weight of the composition, during said step of converting.

In a third embodiment, the present invention provides a method as in either the first or second embodiments, wherein step (d) includes measuring the temperature, thickness, and weight of the composition, during said step of converting.

In a fourth embodiment, the present invention provides a method as in any of the first through third embodiments, further comprising the step of (e) simultaneously measuring the in-plane birefringence and out-of-plane birefringence of the composition during said step of converting.

In a fifth embodiment, the present invention provides a method as in any of the first through fourth embodiments, wherein the step of converting the composition is a drying step.

In a sixth embodiment, the present invention provides a method as in any of the first through fifth embodiments, wherein the step of converting the composition is a polymerization step.

In a seventh embodiment, the present invention provides a method as in any of the first through sixth embodiments, wherein said step of converting is the solidification of a coating or a film, wherein said solidification occurs by solvent evaporation.

In an eighth embodiment, the present invention provides a method as in any of the first through seventh embodiments, wherein said step of converting is a thermal curing or photocuring step that occurs in a controlled atmosphere.

In a ninth embodiment, the present invention provides a method as in any of the first through eighth embodiments, wherein the composition is a polymerizable composition.

In a tenth embodiment, the present invention provides a method as in any of the first through ninth embodiments, wherein steps (d) and (e) are automated.

In an eleventh embodiment, the present invention provides an automated apparatus, comprising a drying element, a temperature pyrometer, a laser displacement sensor, a platform for holding a composition, an electronic balance, and a spectral birefringence measurement system.

In a twelfth embodiment, the present invention provides an apparatus as in the eleventh embodiment, further comprising four or more temperature pyrometers.

In a thirteenth embodiment, the present invention provides an apparatus as in either the eleventh or twelfth embodiments, further comprising three or more laser displacement sensors.

In a fourteenth embodiment, the present invention provides an apparatus as in any of the eleventh through thirteenth embodiments, further comprising a wind tunnel that includes a honeycomb-shaped air diffuser.

In a fifteenth embodiment, the present invention provides an apparatus as in any of the eleventh through fourteenth embodiments, further comprising a light source, wherein the light source is selected from the group consisting of visible light sources and UV light sources.

In a sixteenth embodiment, the present invention provides an apparatus as in any of the eleventh through fifteenth embodiments, wherein the spectral birefringence measurement system is capable of simultaneously measuring the in-plane birefringence and out-of-plane birefringence of a composition.

In a seventeenth embodiment, the present invention provides a method for monitoring and controlling real-time conditions comprising the steps of providing a composition selected from the group consisting of dryable compositions, swellable compositions, solidifiable compositions, polymerizable compositions, and mixtures thereof; providing an apparatus comprising a temperature pyrometer, a drying element, a laser displacement sensor, and an electronic balance; drying, swelling, solidifying, or polymerizing the composition; and measuring the temperature, thickness, weight, in-plane birefringence, and out-of-plane birefringence of the composition.

In an eighteenth embodiment, the present invention provides a method as in the seventeenth embodiment, wherein the composition is a swellable composition.

In a nineteenth embodiment, the present invention provides a method as in either the seventeenth or eighteenth embodiments, wherein the composition is a solidifiable composition.

In a twentieth embodiment, the present invention provides a method as in any of the seventeenth through nineteenth embodiments, wherein the composition is a polymerizable composition.

### BRIEF DESCRIPTION OF THE DRAWINGS

FIG. 1 is a front elevation view of an apparatus of the present invention.

FIG. 2 is a perspective view of a sensor and composition location.

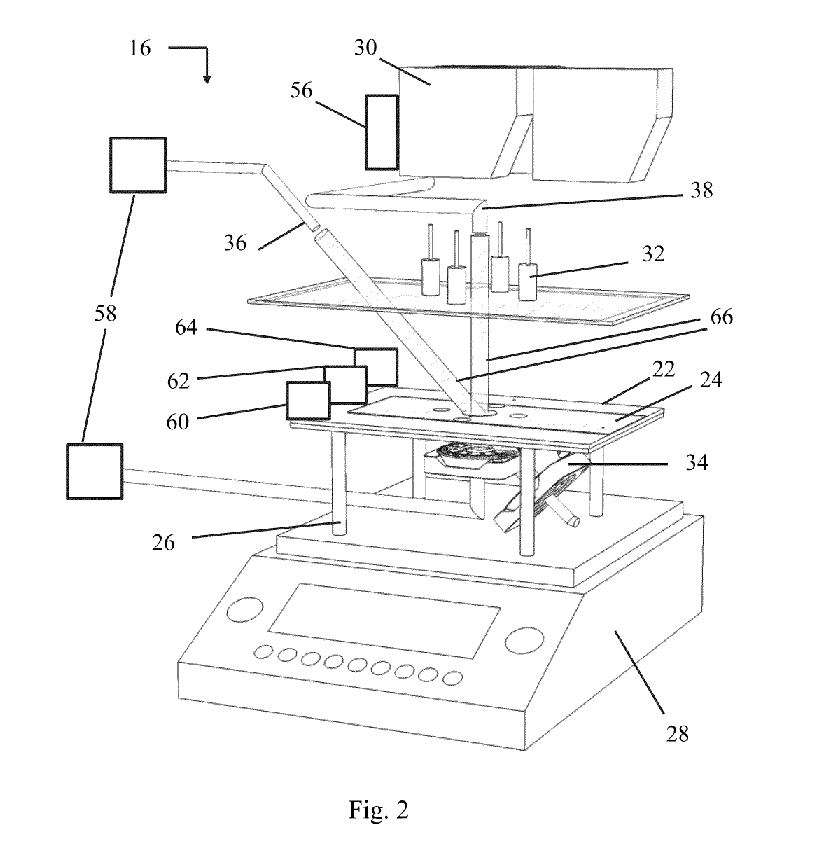

FIG. 3 is a front perspective view of an apparatus of the present invention.

FIG. 4 is a schematic view of a honeycomb-structured air diffuser located inside a tunnel

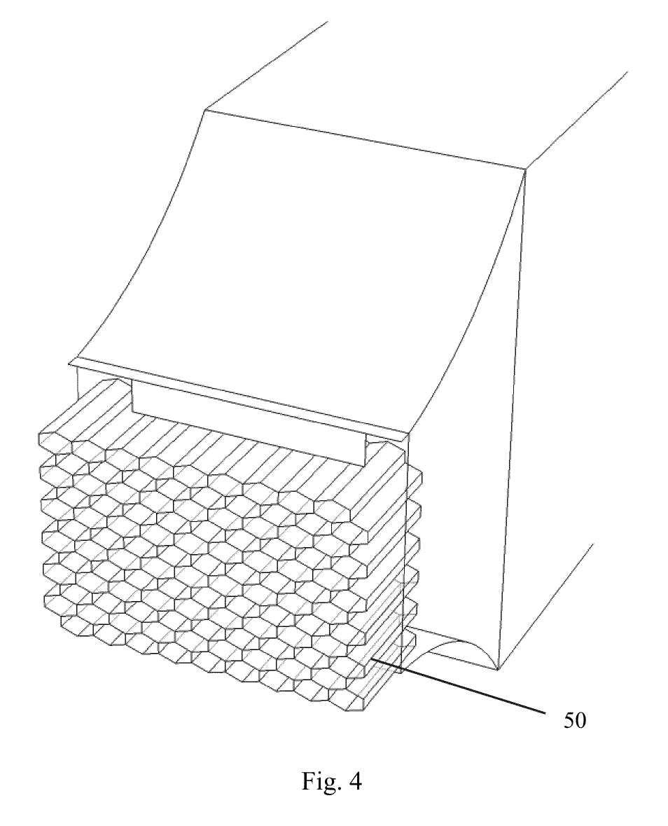

FIG. 5 is a schematic view of vertical baffles location inside a tunnel

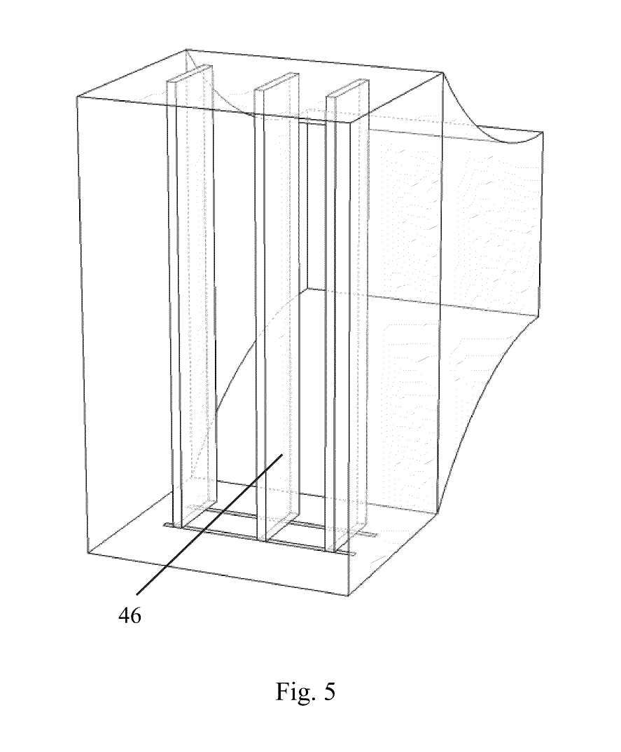

FIG. 6 is a schematic showing the measurement locations for an embodiment of the present invention where a substrate has a composition thereon. The dots (as indicated by the arrows at L1, L2 and L3) are the projections of the positions where laser displacement measurements are performed. The circles (as indicated with P1, P2, P3, and P4) represent the projection of positions where the pyrometer surface temperature readings are obtained. The large circle in the middle represents the position of spectral birefringence measurement.

FIG. 7 is a schematic showing a basic scheme of using three lasers for measuring the thickness of a drying solution.

FIG. 8 is a graph showing the effect of a honeycomb structured air diffuser on high air speed experiments. With the honeycomb air diffuser in the wind tunnel, the noise level of the weight fluctuation is substantially decreased when compared to not having the honeycomb air diffuser in the wind tunnel

FIG. 9 is a graph showing real-time drying data of a PAI-DMAc solution where the stars indicate the offline measurements.

FIG. 10 is a graph showing the % solid and % solvent calculated from the initial concentration and real-time weight data (using the PAI-DMAc solution as in FIG. 9) where the stars indicate the results of thermogravimetric analysis (TGA) for the dried films.

FIG. 11 is a graph showing real-time measurements during UV curing of Urethane-Acrylate with a photo-initiator.

FIG. 12 is a graph showing real-time drying data for water based black paint.

FIG. 13 is a graph showing data for weight (g), thickness (mm) and temperature (° C.) data as a function of time (s) for clay-NMP solution drying.

### DETAILED DESCRIPTION OF ILLUSTRATIVE EMBODIMENTS

The present invention relates to an apparatus for tracking real-time conditions. The present invention further relates to an automated apparatus for monitoring and controlling real-time conditions of a composition transitioning from a liquid state to a solid state. The present invention further relates to a method of monitoring and controlling real-time conditions of a drying process.

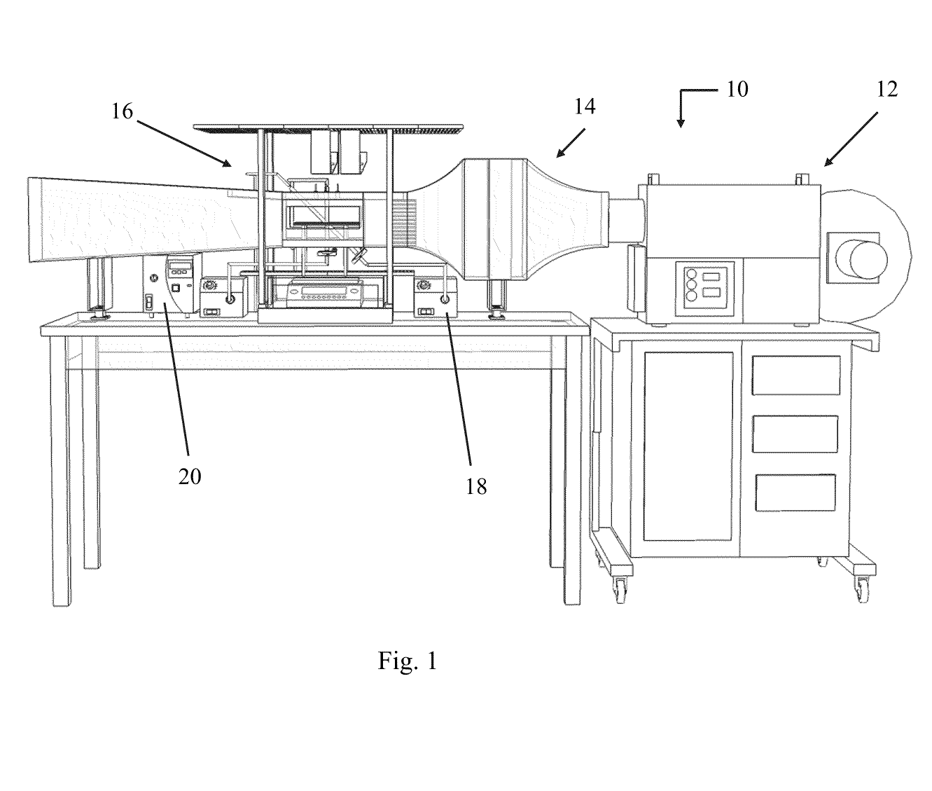

With reference to FIG. 1, an apparatus in accordance with this invention is shown and designated by the numeral 10. The apparatus 10 includes a drying element 12, a tunnel 14, a sensor and composition location 16, visible light sources 18 and a UV light source 20. The apparatus 10 is designed to monitor the real-time conditions of a drying process, and is capable of tracking temporal changes in physical parameters during the drying behavior of solutions or the curing of monomers. The apparatus 10 can also monitor in-plane birefringence, out-of-plane birefringence, weight, thickness, and surface temperature during the course of solidification of coatings and films through solvent evaporation and thermal curing or photocuring in a controlled atmosphere. In particular embodiments, apparatus 10 can simultaneously monitor in-plane birefringence and out-of-plane birefringence.

The apparatus 10 is capable of simulating the properties and conditions of polymer solutions inside an industrial-sized, continuous roll-to-roll solution casting line. The apparatus 10 can also simulate the properties and conditions of coating operations where resins are subjected to UV curing from monomer precursors. It can be used for tracking any systems or processes that include drying, swelling, or solidification. In one or more embodiments, the apparatus 10 tracks systems selected from paper systems, foodstuff systems (e.g. processes involving grains or milk), and pharmaceutical systems (e.g. thin paste and slurries).

In one or more embodiments, processing parameters that can be controlled include air speed, temperature, initial cast thickness, solute concentration, and UV-light intensity. In one or more embodiments, processing parameters that can be measured include thickness, weight, film temperature, in-plane birefringence, and out of plane birefringence.

The sensor and composition location 16 includes a platform 22 having a composition 24 thereon. The platform 22 is supported by legs 26 that are on an electronic balance 28. The electronic balance 28 can be enclosed, such as with a plastic enclosure, to prevent air flow fluctuations in the room from affecting the measurements of the electronic balance 28. An example of a suitable electronic balance includes an electronic balance with a sensitivity of 0.01 g (Sartorius, LA-6200 S).

The sensor and composition location 16 is generally positioned in the middle section of a wind tunnel 14. The platform 22 and the composition 24 are introduced into their location through access ports in the wind tunnel 14. One example of an access port is a glass window in the side of the wind tunnel 14.

In one or more embodiments, the platform 22 is made from materials selected from the group consisting of metal, plastic, ceramics, graphite, glass, and combinations thereof. The platform 22 can have any dimensions that are feasible for the apparatus 10. In one or more embodiment, the platform 22 is six inches or less wide and nine inches or less long.

In one or more embodiments, the composition 24 is selected from the group consisting of solution cast films, solution cast coatings, polymer solutions, monomers, UV curable non-solvent based systems, inorganic materials, slurries, foodstuffs, pharmaceuticals, and mixtures thereof. The composition 24 can have any suitable initial wet thickness. In one or more embodiments, the composition 24 has an initial wet thickness of from 25 micrometer or more to 1 millimeter or less, where the initial wet thickness is the thickness when the composition 24 is first cast prior to a drying process. The apparatus 10 is designed to record the real-time changes in parameters of the composition 24 when the composition 24 transitions from a liquid state to a solid state.

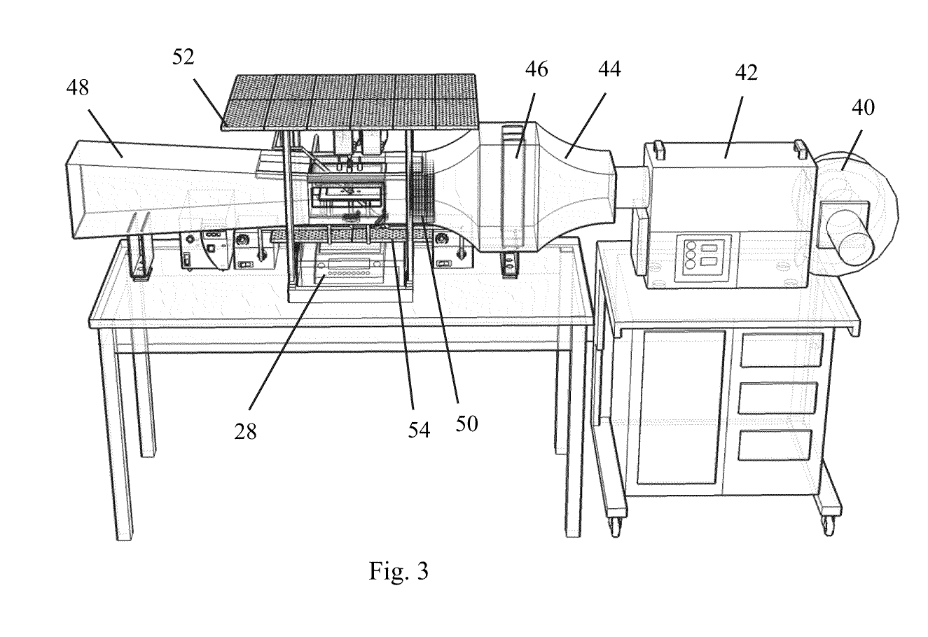

The sensors and components making up the sensor and composition location 16 are generally secured in place, such as through the use of two breadboards. As seen in FIG. 3, one breadboard 52 is located on top and one located at the bottom of the sensor and composition location 16. The top larger breadboard 52 can hold laser displacement sensors 30 for thickness measurement, an upper portion of the bifurcated fiber optic cables 36 and 38, and a USB camera 56. The smaller breadboard 54 at the bottom position can hold a lower portion of the fiber optic cables 36 and 38. These breadboards can be attached to a heavy cast iron base for stability.

In one or more embodiments, a light weight graphite four legged table is used as the sample platform. Graphite has low thermal expansion coefficient and high thermal conductivity. The four legs 26 are rod-shaped and directly contact the surface of the electronic balance 28 for the weight measurement of the composition 24 as it undergoes a process, such as drying. Small openings are made to the bottom surface of the wind tunnel 14 and plastic cover for these legs to go through without any contact.

In a known, conventional roll-to-roll industrial solution casting and drying process, a polymer solution is delivered to a carrier via a casting blade or a slot die. In one or more embodiments of the present invention, a small motorized drawdown coater (Cheminstruments, EZ Coater, Model number: EC-200), is equipped with a commercial 3″ wide, double blade assembly, doctor blade coater to apply the coatings onto a selected substrate, or platform.

Transparency of a substrate and coating or cast polymer can be adjusted for the real-time birefringence measurements as the spectral birefringence method operates in transmission mode. In instances where the optical properties are not important or cannot be measured for highly filled and/or colored samples, non-transparent substrates can be used such as steel, aluminum and ceramics. Glass substrates can be selected for instances where the optical properties of drying solutions are crucial to measure real-time for a transparent optical film production process. The back face of a glass substrate can be painted black to improve the signal quality of a laser displacement sensor. Additionally, a glass substrate may be mostly coated with metals or ceramics while leaving a small portion uncoated for optical birefringence measurement.

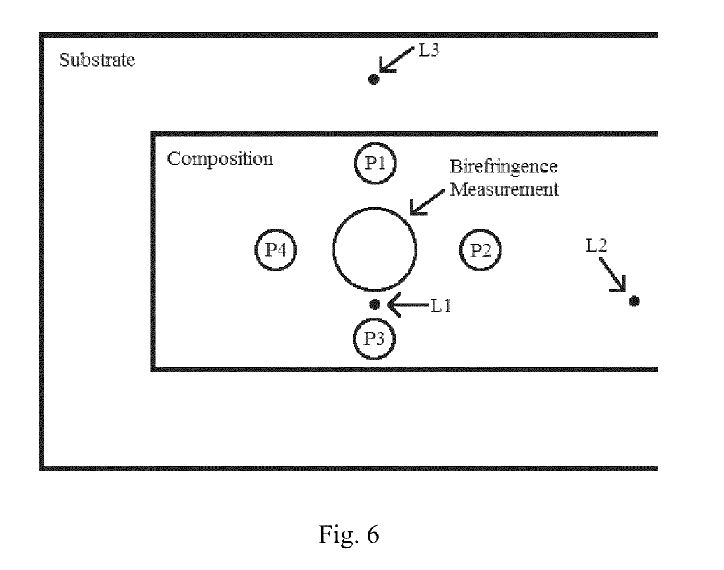

FIG. 6 illustrates a substrate that is coated with a composition as can be used with the apparatus 10. The dots (as indicated by the arrows at L1, L2 and L3) are the projections of the positions where laser displacement measurements are performed. The circles (as indicated with P1, P2, P3, and P4) represent the projection of positions where the pyrometer surface temperature readings are obtained. The large circle in the middle represents the position of spectral birefringence measurement. The real-time measurements are performed in close proximity to the center of the composition such that any edge effects are avoided.

In a typical casting procedure, a prepared polymer solution is introduced inside the reservoir of a doctor blade casting system. The speed on a motorized coater can be adjusted and the moving bar is set in motion. As the bar moves, it pushes the doctor blade on a glass substrate, depositing a desired coating thickness. The coated glass substrate is then placed on top of a sample platform inside a wind tunnel for real-time measurements during a drying process. This casting method is very stable and provides excellent repeatability.

The sensor and composition location 16 includes one or more sensors for monitoring and/or controlling real-time conditions of a process, such as drying. In one or more embodiments, the apparatus 10 includes a fully-automated, spectral birefringence measurement system 58. The birefringence measurement system 58 is sensitive enough to measure very small optical retardation levels (such as in the range of approximately 2-4 nm), which allows this machine to be used with a wide range of materials, including those that exhibit small intrinsic birefringence. This instrument can be used to systematically study the effect of material variables (including solvent types and mixtures and solid concentrations) and system variables (including temperature, air speed, and initial thickness). In addition, these sensors are sensitive enough to track the changes in the physical characteristics of monomers during photocuring.

Real-time optical properties of a drying polymer solution can be measured through the transparent uncoated portion located at the center of a substrate. An optical system can consist of visible wavelength range light sources (Dolan-Jenner MI-152 400 nm to 700 nm), linear polarizers, fiber optic cables, and visible spectrometers (Avantes, Avaspec-NIR256-2.5).

The bifurcated fiber optic cables 36 and 38 are used for in-plane and out-of-plane birefringence measurement using visible light 66, such as white light, and linear polarizers 34. In one or more embodiments, for taking a measurement, a visible light 66, such as 45° linear polarized light, is passed through the sample and collected by bifurcated fiber optic cables 36 and 38. For each angle, one of the fiber optic cables is polarized parallel and the other is polarized perpendicular to the initial polarization. The data is transferred to the spectrometers for further calculations. The detailed instructions and the theory behind such a system are known to one skilled in the art.

Real-time in-plane and out-of-plane birefringence values can be calculated by measuring the retardation (at 546 nm) values at two different angles, 0° and 45°. Other wavelengths in the range of 400 nm or more to 750 nm or less can also be chosen. 546 nm is a preferred embodiment for the particular wavelength as it is in the middle of the visible wavelength range and most optical compensators (offline retardation measurement devices) are calibrated to this wavelength. The measurement of retardations can be done for any wavelength in 400-750 nm range, such as through the use of software.

The in-plane birefringence (Δn₁₂) is calculated by dividing the measured 0° retardation (R₀) by the thickness values (dₘ: stands for real-time thickness values measured by middle laser) (Equation 1). After the optical components are set up, measurements can be taken. Positive in-plane birefringence values indicate that higher refractive index is oriented in the air flow direction, whereas negative in-plane birefringence values indicate that higher refractive index is oriented in the transverse direction of the air flow, particularly with respect to polymers. Out-of-plane birefringence (Δn₂₃ where 2 is transverse or machine direction and 3 is thickness direction) is calculated using the Stein's equation shown below as Equation 2.

$$\begin{matrix}Δ {n}_{12} = \frac{{R}_{0}}{{d}_{m}} & ( Eq . 1 ) \\ Δ {n}_{23} = ( \frac{1}{{d}_{m}} ) [ \frac{{R}_{0} - {{R}_{θ} ( 1 - \frac{{sin}^{2} θ}{{\overline{n}}^{2}} )}^{1 / 2}}{\frac{{sin}^{2} θ}{{\overline{n}}^{2}}} ] & ( Eq . 2 )\end{matrix}$$

In Equation 2, dₘ is the real-time thickness value calculated by a middle laser, R₀ is the measured 0° retardation, R_{Φ} is the retardation value measured at Φ degrees (where Φ=45° in the calculations contained herein), and n̅ is the average (where the bar over the n indicates average) refractive index of the material. With appropriate calibration of average refractive index vs. solvent concentration in the film, the value can be extracted from weight loss data during a drying process.

In one or more embodiments, surface temperature is measured by four separate pyrometers 32 that are focused downwards on the film very close to the center of composition 24. In one or more embodiments, the apparatus 10 includes less than four or more than four pyrometers. Generally, the number of pyrometers is limited or selected based on the geometry of the top glass window. One example of a suitable pyrometer is model thermoMETER-CT from Micro-Epsilon. The pyrometers 32 are mounted on the top glass window by drilling special mounting holes. The temperature readings from these sensors are verified with contact thermocouples.

In one or more embodiments, the thickness of the composition 24 is measured by a combination of three or more non-contact laser displacement sensors 30. In one or more embodiments, the apparatus 10 includes less than three or more than three laser displacement sensors. Generally, the number of laser displacement sensors is limited or selected based on the geometry of the breadboard located on top of the sample platform 22. One example of a suitable laser displacement sensor is model LK-G 152 from Keyence. These sensors are attached to the breadboard located on top of sample platform 22.

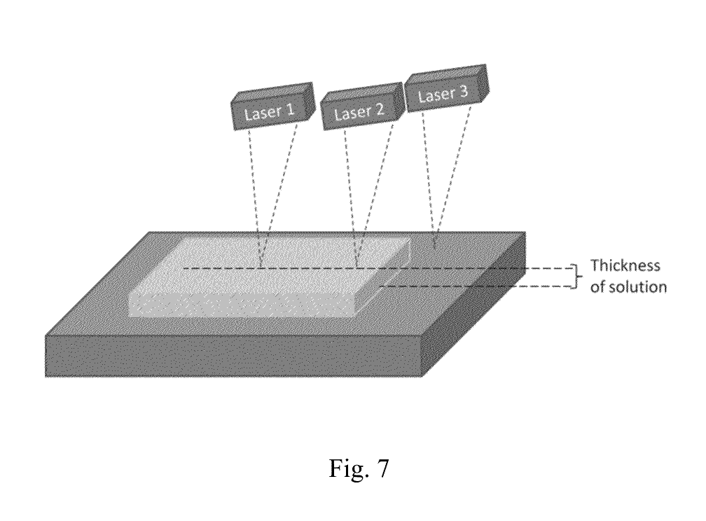

An example of exact measurement positions and their projections on a sample and substrate are shown with dots (L1, L2, L3) in FIG. 6. These sensors measure the position of the top surface of the cast solution through the laser reflection (i.e. reflected laser beams from the surfaces). As shown in FIG. 6, L1 measures the displacement of the surface of a solution in the middle of the film very close to the location where spectral birefringence measurements are made, L2 measures the displacement of the surface of the solution upstream (i.e. towards the heater), and L3 measures the displacement of the surface of a glass substrate. The L3 value can be subtracted from the L1 and L2 values for real-time thickness calculations at those locations. This example of a laser system and method of use is also exemplified in FIG. 7.

This method of using laser beams to measure thickness eliminates the noise that might be caused from the movement of the entire sample platform at high air velocities. It also corrects for any thermal expansion of the sample platform and a substrate on which a composition is placed. The thickness value calculated from L1 and L3 can be used for birefringence calculations.

In one or more embodiments, the apparatus 10 also includes a high definition USB camera 56, such as the LiveCam 9000 model from Microsoft. This camera can be positioned to record images and videos of a composition undergoing a process in order to capture the visual changes during the course of the process.

Any sensors that are included in the apparatus 10 are connected to a computer and the real-time data is acquired via software (e.g. software developed in the Labview platform). A GUI is developed and allows real-time observation of the collected and calculated data. The graphs can be generated as a function of experiment time. Examples of data and graphs that can be generated include weight, laser displacement measurements, calculated thickness values, the 0° and 45° optical retardation values (e.g. in nanometer units), calculated in-plane and out-of-plane birefringence values, and temperature measurements of the pyrometers.

In one or more embodiments, the data acquisition rate is four data points per second. This rate is fast enough to determine the transitions in the most drying processes. In one or more embodiments, the variables that can be tracked and recorded real-time by this system include the weight, thickness (using three laser measurements), surface temperature at four positions, and in-plane and out-plane-plane spectral birefringence (such as for drying polymer solutions).

In one or more embodiments, the apparatus 10 includes visible range light sources 18 and UV wavelength range light sources 20. These light sources could be used in order to simulate different processing methods, such as for monitoring and/or controlling the photopolymerization of UV curable monomer films with a solventless process. In one or more embodiments, one or more light sources can take the place of one or more of the pyrometers 32.

For example, a UV light source can be introduced via a fiber optic cable, and the dynamics of real-time UV curing can be analyzed. These measurements allow for the rapid capture of the measurement parameters, thereby tracking the kinetics of the curing process. This can help in the understanding of applications such as lamination, photocuring liquid crystals, and optical storage applications (e.g. holograms).

In one or more embodiments, particularly for those embodiments having a composition 24 that is to undergo a drying process, the apparatus 10 includes a drying element 12. As seen in FIG. 3, the drying element 12 can include a motor 40 and a hot air blower 42. The drying element 12 creates heat and/or air in order to dry, or otherwise effect, the composition 24. The air is blown through the wind tunnel 14 and circulates above the composition 24. This circulation convectively heats the composition 24. The apparatus 10 can also include a series of drying zones that are heated by under-bed heaters. The platform 22 and the composition 24 would pass through these drying zones and be heated from underneath the platform.

One example of a suitable hot air blower is model number TSK-52HT (Type 3200-17C-025Y-LB-HT) from Taketsuna Company. In one or more embodiments, the drying element 12 is capable of setting temperatures between ambient and 500° C. at air speeds up to 6 m/s.

The air blower 42 is connected to a wind tunnel first portion 44. Air flows generally from the air blower 42 to the wind tunnel first portion 44 to the wind tunnel second portion 48. The wind tunnel first portion 44 includes adjustable vertical baffles 46 that are used to fine tune the uniformity of flowing air. These baffles can be adjusted and locked, such that the air speed at various locations inside the sample position can be measured by an external anemometer.

The middle section of wind tunnel 14 is modified to allow the composition 24 to be introduced inside. In one or more embodiments, the wind tunnel 14 includes glass windows on the sides in order to introduce the sample inside. Top and bottom sections of the middle portion of the wind tunnel 14 can also be replaced with anti-reflection coated glasses for observing the process, monitoring non-contact laser thickness, and measuring in-plane and out-of-plane birefringence.

The shape of the wind tunnel 14 is designed as a wind tunnel in order to provide a uniform air flow for the composition 24. The frame of the wind tunnel 14 can include two layers of metal enclosures that are separated with a thermal insulation material in between. Aluminum can be utilized for its high solvent and corrosion resistivity.

In one or more embodiments, the wind tunnel 14 includes a honeycomb structure air diffuser 50. One example of a suitable diffuser is model PCGA-XR1 3003 Aluminum Honeycomb from Plascore. The air diffuser 50 can be placed inside the wind tunnel 14 to streamline the air arriving to the platform 22 downstream. The air diffuser 50 also eliminates potential noise from weight data acquired from the electronic balance for high air speed (e.g. approximately 6 m/s) experiments.

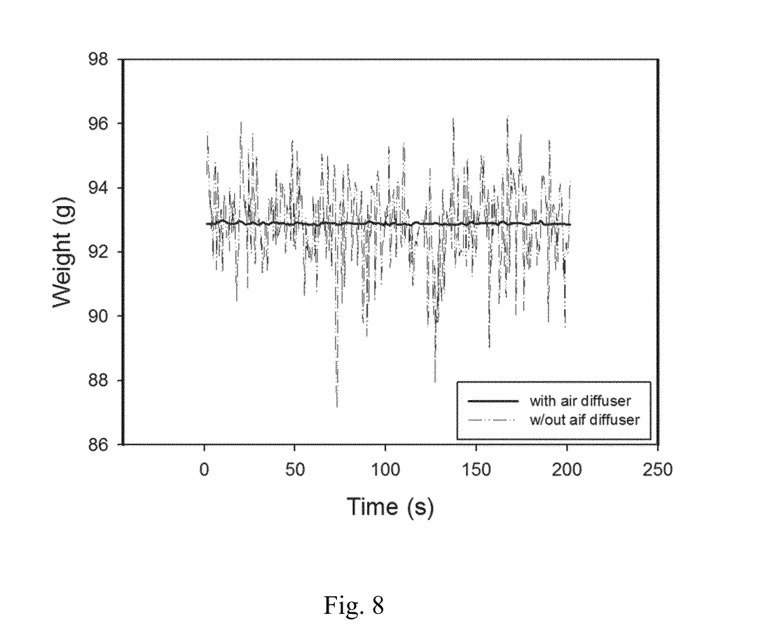

FIG. 8 shows the noise levels in an unloaded weight measurement system with and without the air diffuser. Before insertion of the honeycomb air diffuser 50, the weight fluctuation during a typical run was around 8 g at 6 m/s. After placing the honeycomb air diffuser 50 into the wind tunnel 14, the noise level substantially decreased to 0.18 g. In similar examples, the air speed was measured at different locations before and after the insertion of the honeycomb structure and no significant changes were observed.

The downstream portion of the wind tunnel 14, wind tunnel second portion 48, is open to the atmosphere. An exhaust can be positioned close to this opening in order to collect any solvent-containing air coming out from the wind tunnel 14. The exhaust inlet can be separated by about 2″ from the end of the wind tunnel 14 so as not to cause excess vacuum by the air handling system.

In one or more embodiments, the apparatus 10 includes an ultrasound device 60. An ultrasound device is one that uses ultrasound, an oscillating sound pressure wave with a frequency greater than the upper limit of the human hearing range, such as to detect an object or measure distances. In one or more embodiments, an ultrasound device 60 is used to track the thickness of a solidified skin during drying. In one or more embodiments, the apparatus 10 includes a gas chromatography mass spectrometer (GC-MS) 62. GC-MS is an analytical method that combines the features of gas-liquid chromatography and mass spectrometry to identify different substances within a sample. In one or more embodiments, the apparatus 10 includes a near-infrared device 64. Near-infrared spectroscopy is a spectroscopic method that uses the near-infrared region of the electromagnetic spectrum (from about 800 nm to 2500 nm). Near-infrared spectroscopy is useful in tracking chemically specific changes in a cast liquid. This can include chemical reactions (if any), preferential solvent content in multi solvent systems, and any other chemical changes that can occur during the course of solidification.

In particular embodiments of the present invention, apparatus 10 measures and/or controls process variables for the following samples: a solution cast and dried poly (amide-imide)/DMAc solution, water based black paint, and organo-modified clay/NMP solution. In one or more embodiments, the apparatus 10 can track the physical changes that take place during UV photopolymerization of a monomer.

The present invention also relates to a method of using apparatus 10. In one or more embodiments, a method of monitoring a composition in transition from liquid to solid state comprises the steps of: (a) providing an apparatus comprising a temperature pyrometer, a drying element, a laser displacement sensor, and an electronic balance; (b) providing a composition in a liquid state; (c) converting the composition to a solid state; and (d) measuring a process condition selected from the group consisting of temperature, thickness, and weight of the composition during said step of converting. In one or more embodiments, a method of monitoring a composition in transition from liquid to solid state further comprises the step of (e) simultaneously measuring the in-plane birefringence and out-of-plane birefringence of the composition. In one or more embodiments, a method of monitoring a composition in transition from liquid to solid state comprises the steps of: (a) providing a composition in a liquid state; (b) converting the composition to a solid state; and (c) measuring a process condition of said composition during said step of converting.

In one or more embodiments, a method of use includes converting the composition from liquid to solid state through a drying step. In one or more embodiments, a method of use includes converting the composition from liquid to solid state through a polymerization step. In one or more embodiments, a method of use includes converting the composition from liquid to solid state through the solidification of a coating or a film, where the solidification can occur by solvent evaporation. In one or more embodiments, a method of use further comprises the step of simultaneously monitoring in-plane birefringence and out-of-plane birefringence. In one or more embodiments, a method of use includes measuring weight, thickness, surface temperature, or mixtures thereof.

In one or more embodiments, a method for monitoring real-time conditions includes the steps of providing a composition selected from the group consisting of dryable compositions, swellable compositions, solidifiable compositions, polymerizable compositions, and mixtures thereof; providing an apparatus capable of measuring real-time conditions; drying, swelling, solidifying, or polymerizing the composition; and measuring the real-time conditions of the drying, swelling, solidification, or polymerization.

### EXAMPLES

### Example A

### Poly(amid-imide)/DMAc Solution—Real-Time Data and Verification with Offline Methods

Example A was performed with a poly (amide-imide) solution (PAI) (provided by Akron Polymer Systems, APS) in Dimethylacetamide (DMAc) as the solvent (Sigma Aldrich, synthesis grade) with 8 wt % concentration. 0.5 m/s air speed and 50° C. drying temperature was selected as the experimental process. The system was pre-heated to the desired temperature and a 500 μm thick solution was cast on the glass substrate and placed on the sample platform.

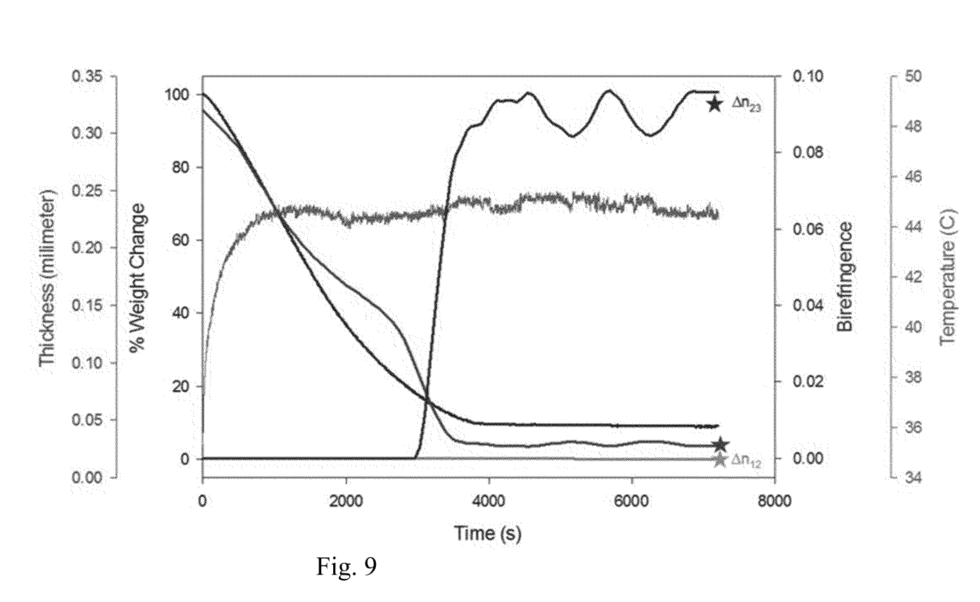

FIG. 9 represents the real-time % weight change (measured from the initial stage), thickness (mm), temperature (° C.), in-plane and out-of-plane birefringence data as a function of time for PAI/DMAc solution drying experiment. The weight and thickness values decreased and leveled off beyond a critical value as solvent evaporates. The thickness data showed interference pattern below a certain thickness value. This pattern was also reflected to the birefringence data, since thickness was used to calculate the in-plane and out-of-plane birefringence. Surface temperature values remained nearly constant through the experiment after it reached a plateu. In-plane birefringence (Δn₁₂) remained constant during the drying. This indicated that there was no in-plane preferential orientation of the polymer chains. However, out-of-plane birefringence (Δn₂₃) rapidly increased to a high value around 3000 seconds, indicating preferential orientation of the axes of the polymer chains in the film plane.

The data for this experiment was verified with the offline characterization methods. The thickness of the final dried film was measured by a precision micrometer and the measured value was marked with a star on FIG. 9.

The in-plane and out-of-plane birefringence data on final dried film was verified by using a Gaertner optical bench polariscope (Model L305; Gaertner Scientific Co.) equipped with a 7 order Babinet compensator (GSC No. 617-F). Equation (1) and (2) were used for the calculations and wavelength of 565 nm was used since the instrument was calibrated for this specific wavelength. The end results for in-plane birefringence (star) and out-of-plane birefringence (star) are indicated in FIG. 9. They were in very good agreement with the final values obtained on-line.

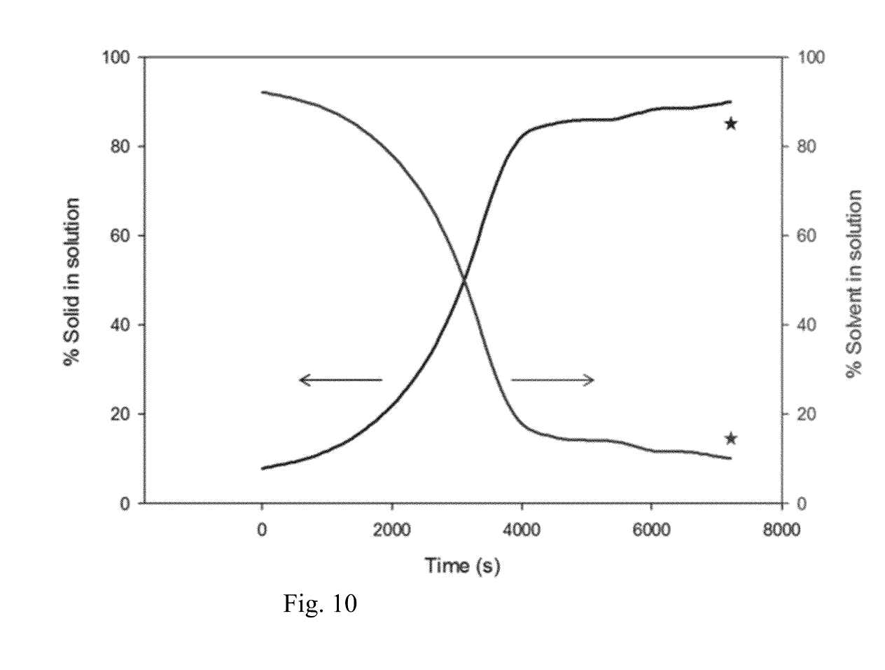

Thermogravimetric analysis (TGA) was used to verify the weight data and amount of remaining bound solvent was calculated and compared with the real-time experimental data. FIG. 10 represents the % solid and solvent change as a function of time, calculated from the initial concentration of the solution and the real-time weight data. At the end of the experiment, the present system showed there is 12% bound solvent with-in the film and the TGA data showed there is 17% bound solvent. This difference was mainly due to the sensitivity of the electronic balance (0.01 g). For this specific experiment, the total solid content of the cast solution is 0.3 g and 0.01 g difference causes 3% fluctuation on the weight data for dried film. From FIG. 9 and FIG. 10 it can be concluded that the real-time measured physical parameters are very close to the values that are measured with standard offline characterization methods.

A series of the images were recorded with a camera for PEO in water (10 wt %) solution. The air flow direction was from right to left and formation and propagation of the drying front was observed. These images were captured so that the movement of distinct wet/semidry boundary could be tracked. This occurs in all drying operations.

### Example B

### Photopolymerization of Cast Film

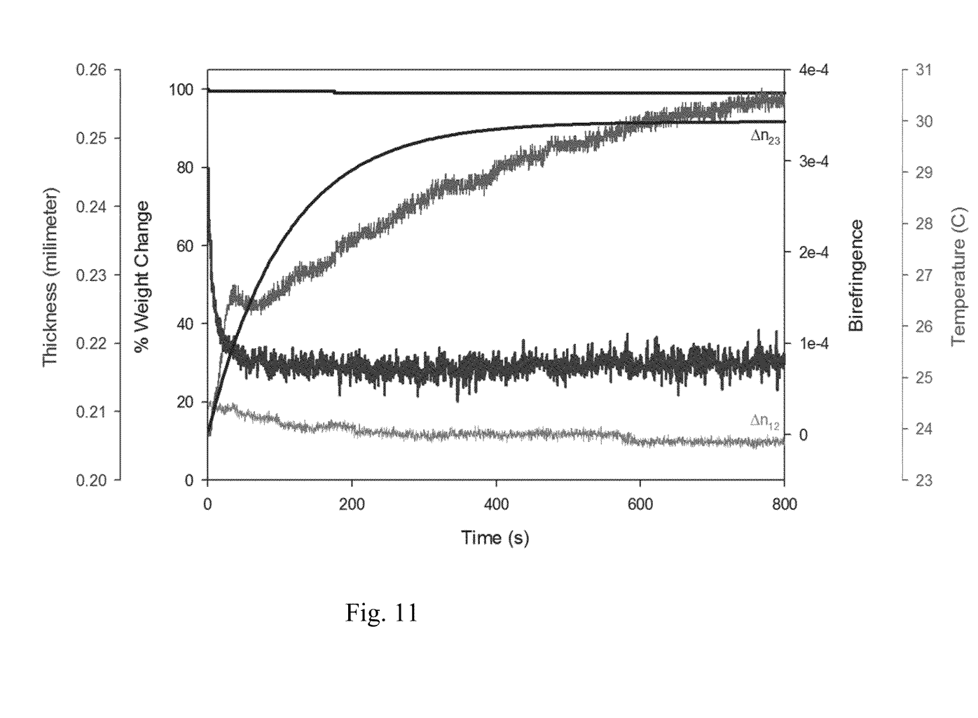

FIG. 11 represents the real-time data of UV curing for doctor blade cast urethane acrylate and 5% photo-initiator mixture. No weight change was observed during these experiments where only initiation, propagation, chain transfer, and termination occur in these solvent free monomers. A total of 10% thickness change was observed in these samples at the early stages of the experiment. This early stage can be called the precuring period. Also a sharp 3° C. increase was noted on the temperature during the precuring period. The temperature continued to increase at a slower rate, which might be the heating effect due to a UV lamp on the sample. The in-plane birefringence remained very close to zero values, while a slight increase and then levelling off behavior was observed for the out-of-plane birefringence. Even though the increase was a very small value, the instrument was sensitive enough to measure such small changes for solution casting or UV curing process.

### Example C

### Drying of a Water Based Paint

For Example C, a commercially available water based black paint (Glidden Ultra-Hide 1210-9990V) was used. A thin layer of paint was cast on top of an aluminum metal substrate and dried at room temperature inside the instrument. The air speed was set to 0.5 m/s and initial cast thickness was set as 560 μm for this experiment.

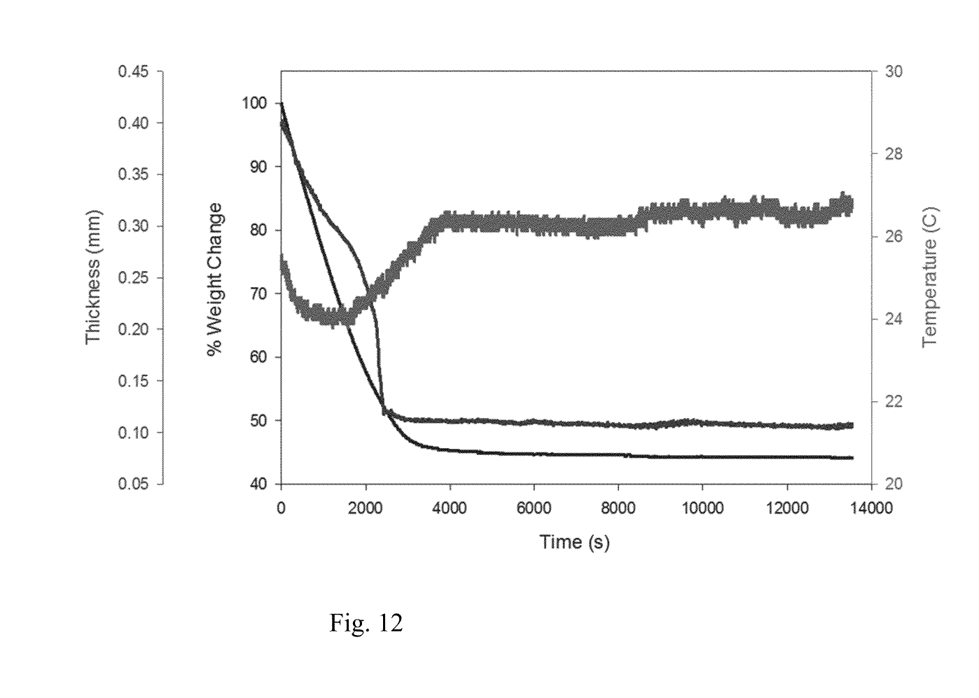

Real-time weight, thickness, and surface temperature data is presented at FIG. 12. The weight and thickness change were monitored as the solvent evaporates. The surface temperature showed an initial decrease due to evaporative cooling, passed through a minimum level, and started to increase as the material solidifies and rate of solvent evaporation decreased as it is depleted in the film. These results were in good agreement with previous results recorded in the art. Due to opaqueness of the substrate and black color of this coating, the optical retardation was not measured in this system.

### Example D

### Drying of Clay Solution

For the last experiment, Cloisite 30B® organo-modified clay (provided by Southern Clay Products, Inc) in NMP as solvent (Sigma Aldrich, synthesis grade) was prepared with 3 wt % solid concentration. 0.5 m/s air speed and 70° C. drying temperature were selected as the process parameters. The system was pre-heated to desired temperature and 1 mm thick solution was cast on the glass substrate and placed on the sample platform.

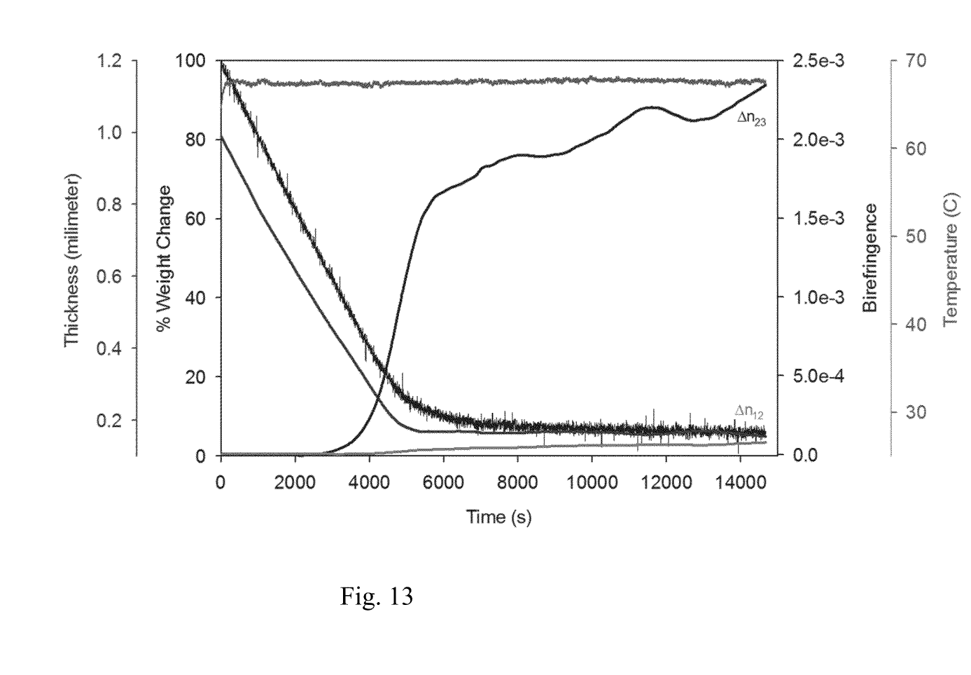

FIG. 13 represents the real-time data for Example D, a clay solution drying experiment. The weight and thickness values decreased and leveled off beyond a critical value as solvent evaporated and temperature remained nearly constant throughout the experiment. Similar birefringence behavior was observed for the clay solutions compared with the PAI/DMAc solutions. The in-plane birefringence values remained constant during the drying, and at a critical point, out-of-plane birefringence rapidly increased. This indicates that the there was no in-plane preferential orientation of the clay platelets whereas preferential orientation of the planes of the clay platelet in the film plane occurred. It is important to note that montmorillonite nanoplatelets have negative optical birefringence with intrinsic refractive indices reported as n out of plane=1.485 and n in-plane=1.505-1.55.

In light of the foregoing, it should be appreciated that the present invention significantly advances the art by providing an improved apparatus for tracking and/or controlling real-time conditions. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A method of monitoring a composition in transition from liquid to solid state, comprising the steps of:
(a) providing an apparatus comprising a temperature pyrometer, a drying element, a laser displacement sensor, and an electronic balance;
(b) providing a composition in a liquid state;
(c) converting the composition to a solid state; and
(d) measuring a process condition selected from the group consisting of temperature, thickness, and weight of the composition, during said step of converting.

2. The method of claim 1, wherein step (d) includes measuring two or more of the process conditions selected from the group consisting of temperature, thickness, and weight of the composition, during said step of converting.

3. The method of claim 1, wherein step (d) includes measuring the temperature, thickness, and weight of the composition, during said step of converting.

4. The method of claim 1, further comprising the step of:
(e) simultaneously measuring the in-plane birefringence and out-of-plane birefringence of the composition, during said step of converting.

5. The method of claim 1, wherein the step of converting the composition is a drying step.

6. The method of claim 1, wherein the step of converting the composition is a polymerization step.

7. The method of claim 1, wherein said step of converting is the solidification of a coating or a film, wherein said solidification occurs by solvent evaporation.

8. The method of claim 1, wherein said step of converting is a thermal curing or photocuring step that occurs in a controlled atmosphere.

9. The method of claim 1, wherein the composition is a polymerizable composition.

10. The method of claim 4, wherein the steps (d) and (e) are automated.

11. An automated apparatus, comprising
a drying element,
a temperature pyrometer,
a laser displacement sensor,
a platform for holding a composition,
an electronic balance, and
a spectral birefringence measurement system.

12. The apparatus of claim 11, further comprising four or more temperature pyrometers.

13. The apparatus of claim 11, further comprising three or more laser displacement sensors.

14. The apparatus of claim 11, further comprising a wind tunnel that includes a honeycomb-shaped air diffuser.

15. The apparatus of claim 11, further comprising a light source, wherein the light source is selected from the group consisting of visible light sources and UV light sources.

16. The apparatus of claim 11, where the spectral birefringence measurement system is capable of simultaneously measuring the in-plane birefringence and out-of-plane birefringence of a composition.

17. A method for monitoring and controlling real-time conditions comprising the steps of
providing a composition selected from the group consisting of dryable compositions, swellable compositions, solidifiable compositions, polymerizable compositions, and mixtures thereof;
providing an apparatus comprising a temperature pyrometer, a drying element, a laser displacement sensor, and an electronic balance;
drying, swelling, solidifying, or polymerizing the composition; and
measuring the temperature, thickness, weight, in-plane birefringence, and out-of-plane birefringence of the composition.

18. The method of claim 17, wherein the composition is a swellable composition.

19. The method of claim 17, wherein the composition is a solidifiable composition.

20. The method of claim 17, wherein the composition is a polymerizable composition.
